(19) United States
(12) Patent Application Publication
(10) Pub. No.: US 2024/0392745 A1
(43) Pub. Date: Nov. 28, 2024

(54) MULTI-VECTOR WIND TURBINE

(71) Applicant: Samantha Narelle Kirkland, Franklin, NC (US)

(72) Inventor: Samantha Narelle Kirkland, Franklin, NC (US)

(21) Appl. No.: 18/669,681

(22) Filed: May 21, 2024

Related U.S. Application Data
(60) Provisional application No. 63/469,282, filed on May 26, 2023.

(51) Int. Cl. F03D 3/00; F03D 3/04; F03D 9/25

(52) U.S. Cl. CPC F03D 3/009; F03D 3/0472; F03D 9/25; F05B 2220/7068

(57) ABSTRACT

A wind turbine system includes a frame including a first arm and a second arm. The wind turbine system includes a wind turbine coupled between the first arm and the second arm. The wind turbine includes a shaft and a plurality of blades coupled to the shaft. The plurality of blades interact with a wind to rotate the shaft. The wind turbine also includes a wind direction device. The wind direction device is configured to block the wind from interacting with one or more of the plurality of blades moving in a movement direction counter to a wind direction of the wind. The wind turbine system includes at least one generator coupled to the wind turbine, wherein the generator is configured to convert mechanical energy of the wind turbine to electrical energy.

### CROSS-REFERENCE TO RELATED APPLICATIONS

This application claims the benefit of priority of U.S. provisional application No. 63/469,282, filed May 26, 2023, titled “Multi-vector wind turbine,” the entire contents of which are herein incorporated by reference.

### FIELD

The present disclosure relates to electric power generation and, more particularly, to wind turbines.

### BACKGROUND

Due to the impact of fossil fuels on the environment, alternative sources of electrical power generation are critical. One alternative is wind turbine power generation. Wind turbine power generation harnesses the kinetic energy of the wind to produce electricity. The existing wind generation devices require constant maintenance, exorbitant construction cost, ever-present risk of injury to wildlife/failure of parts, noise issues, and political resistance of NIMBY.

As can be seen, there is a need for wind turbines that address the above drawbacks.

### SUMMARY

In one aspect of the present disclosure, a wind turbine system includes a frame including a first arm and a second arm. The wind turbine system includes a wind turbine coupled between the first arm and the second arm. The wind turbine includes a shaft and a plurality of blades coupled to the shaft. The plurality of blades interact with a wind to rotate the shaft. The wind turbine also includes a wind direction device. The wind direction device is configured to block the wind from interacting with one or more of the plurality of blades moving in a movement direction counter to a wind direction of the wind. The wind turbine system includes at least one generator coupled to the wind turbine, wherein the generator is configured to convert mechanical energy of the wind turbine to electrical energy.

### BRIEF DESCRIPTION OF THE DRAWINGS

FIG. 1 is a front perspective view of a wind turbine system, according to aspects of the present disclosure;

FIGS. 2A-2C are cross-sectional views of examples of the wind turbine system, according to aspects of the present disclosure;

FIG. 3 is a perspective view of an example of a rotor of the wind turbine system, according to aspects of the present disclosure;

FIGS. 4A and 4B are cross-sectional views of operations of the wind turbine system, according to aspects of the present disclosure;

FIGS. 5A and 5B are views of examples of blades, according to aspects of the present disclosure;

FIGS. 6A-6E are cross-sectional views of examples of a dual wind turbine system, according to aspects of the present disclosure;

FIG. 7 is a cross-sectional view of another example of a dual wind turbine system, according to aspects of the present disclosure;

FIG. 8 is cross-sectional view of an example of a horizontal, dual wind turbine system, according to aspects of the present disclosure; and

FIG. 9 is a cross-sectional view of an example of another wind turbine system, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, conventional wind turbine power generation systems have several drawbacks. Wind turbine systems typically include large blades mounted on a tower. The blades are designed to capture the energy from the wind, e.g., rotate in response to interaction with wind. As the blades turn, a rotor spins, which connected to a generator inside the wind turbine system. Inside the generator, the rotational motion of the rotor produces an electric current through the principles of electromagnetic induction. Wind farms usually consist of multiple turbines, all connected to a common grid. The electricity generated by these turbines is combined and fed into the grid, where it mixes with electricity from other sources. Wind turbine systems, however, must be equipped with control systems that optimize their performance based on factors like wind speed and direction. The control systems can adjust the angle and/or direction of the blades to efficiently capture wind energy as wind velocity changes, e.g., magnitude and/or direction.

Broadly, an embodiment of the present disclosure provides a wind turbine system that efficiently produces electrical power from multiple direction, without the need for the control systems. The wind turbine system can be mounted on a tower or on/within a building that is omni-directional, composed of commonly available materials for the physical structure. The wind turbine system is quiet, self-lubricating, low maintenance, and made of parts readily available worldwide. In embodiments, components of the wind turbine system can be constructed of carbon fiber/carbon nanotubes so constructed as to provide endless power generation at no cost once operating in place.

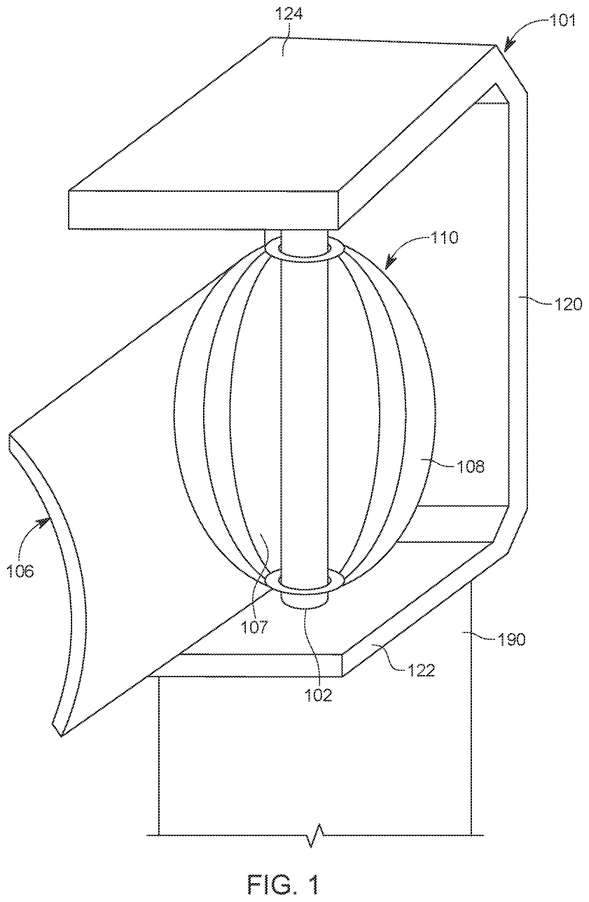

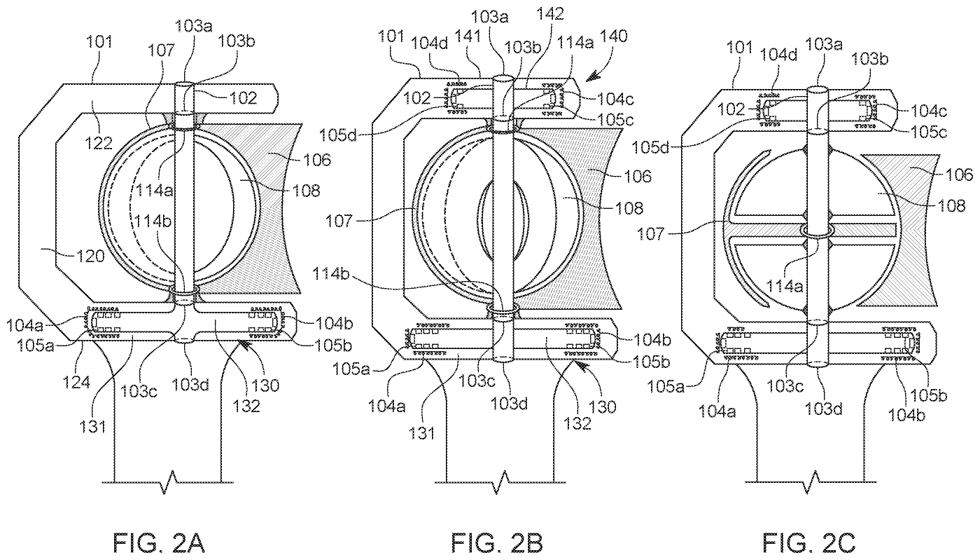

Referring now to Figures, FIGS. 1 and 2A-2C illustrate examples of a wind turbine system 100, according to aspects of the present disclosure. While FIGS. 1 and 2A-2C illustrate examples of components of the wind turbine system 100, additional components can be added and existing components can be removed and/or modified.

As illustrated in FIG. 1, which is a perspective view, the wind turbine system 100 includes a frame 101 that supports a wind turbine 110. In some embodiments, as illustrated, the frame 101 can be “C” shaped having a vertical bar 120, a lower arm 122, and an upper arm 124. The wind turbine 110 includes a number of blades 108 coupled to a shaft 102. The shaft 102 extends vertically from the lower arm 122 to the upper arm 124, thereby rotatably coupling the wind turbine 110 to the frame 101. The blades 108 operate to interact with the wind to convert a force of the wind into a torque on the shaft 102. The torque causes the shaft 102 to rotate. The blades 108 can be drag-type devices. As discussed in further detail below, the shaft 102 is coupled to one or more generators that operate to convert the mechanical energy of the rotating shaft into electrical energy. The frame 101 can be coupled to a pole or column 190 that holds the frame 101.

For example, as illustrated in FIG. 2A, which is cross-sectional views of one configuration, the shaft 102 extends into the lower arm 122 and the upper arm 124. The lower arm 122 and the upper arm 124 can include bearings, e.g., bearing 103a, 103b, 103c, and 103d, that allow the shaft 102 to rotate. In one example, as illustrated in FIG. 2A, the wind turbine system 100 can include a generator 130 positioned within the lower arm 122. The generator 130 can include a chamber 131 that houses a rotor 132. The rotor 132 is coupled to the shaft 102. The chamber 131 is configured to allow the rotor 132 to spin as the shaft 102 spins.

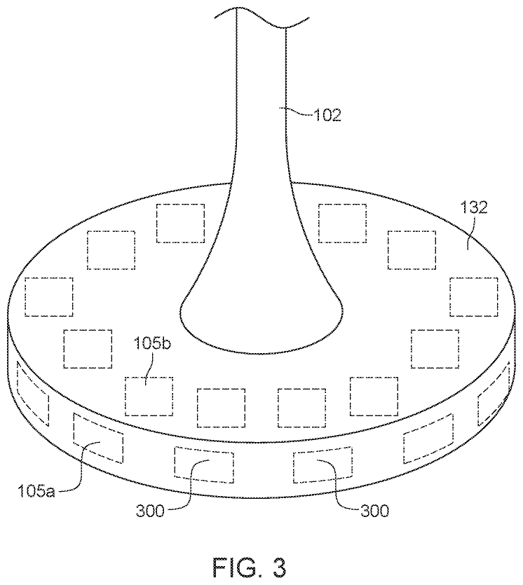

As illustrated in FIG. 3, the rotor 132 can be configured as a disk that spins within the chamber 131. The rotor 132 includes magnets 300 positioned at both ends of the rotor 132. For example, the rotor 132 can include one or more magnets 105a positioned adjacent to an exterior edge of the disk and can include one or more magnets 105b positioned adjacent to a top surface and/or bottom surface of the disk. The generator 130 can also include electrical coils positioned around the chamber 131, e.g., coils 104a and 104b, as illustrated in FIGS. 2A-2C. As the rotor 132 spins within the chamber 131, an electrical current is generated in the coils, e.g., coils 104a and 104b. A transmission line and/or lines can be coupled to the coils, e.g., coils 104a and 104b to transmit the generated electrical energy.

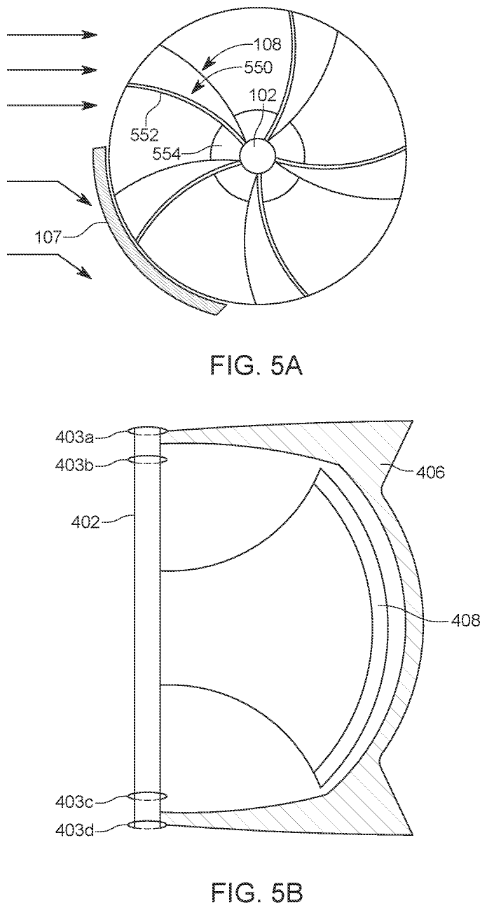

In the example of FIG. 2A, the blades 108 can be configured as scoops, as further illustrated in FIGS. 5A and 5B. In some embodiments, as illustrated in FIG. 5A, which is a bottom-up view of the blades 108, the wind turbine 101 can include five (5) scoop-shaped blades 108 equally spaced around the circumference of the shaft. Because of the curvature of the scoops, the blades 108 are curved to “capture” incoming wind and experience less drag when moving against the wind than when moving with the wind. The differential drag causes the wind turbine 110 to spin. The blade 108 can have a “scoop” shape with a convex leading side 550 in the direction of motion, and a convex scoop to capture the wind. The blade 108 can have a thicker body at a center point, tapering at both ends at the connection point to the shaft 102. At the mid-point of the blades, each blade 108 can have an arc width of θ₁, with each blade 108 being spaced apart by an arc width of θ₂; the arc width is measured on an imaginary circle drawn around the wind turbine at the midpoint, for example, the cross-sectional plane illustrated in FIG. 5A. In some embodiments, the sum of θ₁ and θ₂ can be 72 degrees. In some embodiments, θ₁ can be 15 degrees. In some embodiments, one or more edges 552 of the blades 108 can be reinforced to provide structural support to the blades 108. In some embodiments, the blades 108 can include a bottom and/or top cap 554.

In another example, as illustrated in FIGS. 2B and 2C, which are cross-sectional views of one configuration, the wind turbine system 100 can include a generator 140 positioned within the upper arm 124, in addition to the generator 130. The generator 140 can include a chamber 141 that houses a rotor 142. The rotor 142 is coupled to the shaft 102. The chamber 141 is configured to allow the rotor 142 to spin as the shaft 102 spins. The rotor 142 includes magnets positioned around the disk of the rotor 142, e.g., magnets 105c and 105d. The generator 130 can also include electrical coils positioned around the chamber 141, e.g., coils 104c and 104d. As the rotor 142 spins within the chamber 141, an electrical current is generated in the coils, e.g., coils 104c and 104d. A transmission line and/or lines can be coupled to the coils, e.g., coils 104a, 104b, 104c, and 104d, to transmit the generated electrical energy.

As discussed above, in the example of FIG. 2A, the blades 108 can be configured as scoops, as further illustrated in FIG. 5A. In some embodiments, the wind turbine 100 can include five (5) scoop-shaped blades 108 equally spaced around the circumference of the shaft. Because of the curvature of the scoops, the blades 108 experience less drag when moving against the wind than when moving with the wind. The differential drag causes the wind turbine 110 to spin. In the example of FIG. 2B, the wind turbine 100 can include scoop-shaped blades 108 that are varied in size and equally spaced around the circumference of the shaft, thereby forming inner and outer blades. In the example of FIG. 2C and FIG. 5C, the wind turbine 100 can include fan-shaped or axe-shaped blades 108. In any of the embodiments, the blades of the wind turbine can be constructed of a rigid or semi-rigid material to capture the wind, for example, carbon fiber.

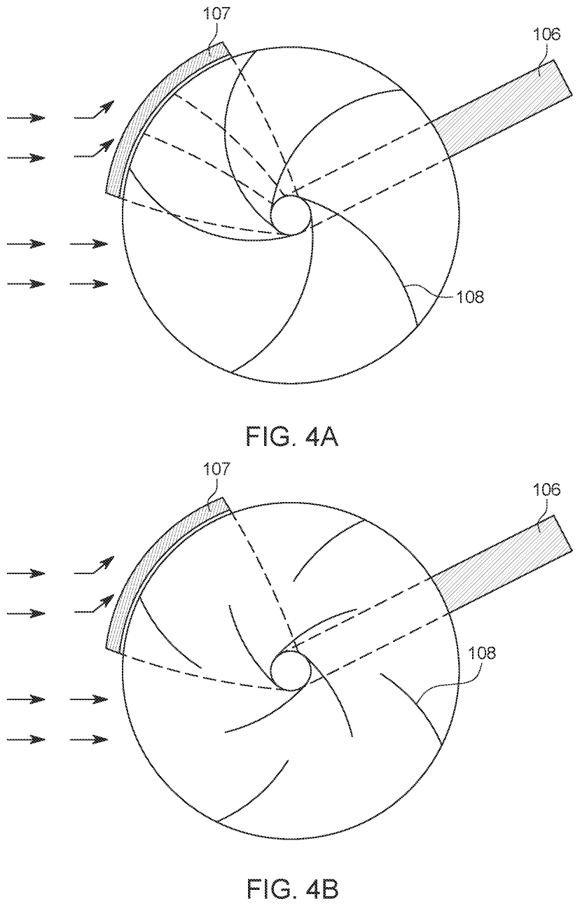

The wind turbine 110 includes a wind direction device 112. The wind direction 112 includes a wind vane 106 and a negative wind screen 107. The wind direction device 112 is movable coupled to the shaft 102 and includes bearings, e.g., 114a and 114b, that allow the wind direction device 112 to move independently of the rotation of the shaft 102. In operation, as illustrated in FIGS. 4A and 4B, the blade 108, e.g., blade sphere, is free to be rotated by the wind vector. One side of the sphere has blades scooped to accept and react to the force of the wind by being pushed forward and around the axis. As the wind begins pushing to rotate the blade sphere, the wind vane 106 moves parallel to the wind vector, thereby positioning the negative wind screen 107 opposite the oncoming wind so as to block its effect on the back of the returning blades, i.e., shunting the now negative wind to the side.

The blade sphere can designed to spin in a counterclockwise or counterclockwise direction based on the curvature of the blades 108 and the positioned of the wind screen 107. For example, the 5-bladed sphere is mounted on six (6) sets of roller bearings, which, in effect, make it very easy to turn. As the wind enters the scoop of one of the facing blades, it causes it to move away, thereby rotating the “sphere” axle. This allows the following blade to enter the wind effect space prior to the dissipation of wind effect on the preceding blade, keeping the sphere rotating continuously, whether in winds below 5 m/s or even in excess of 150 mph. The wind vane 106 is simple in design but operates to improve the efficiency of the wind turbine system 100. From whatever compass point the wind comes, the wind vane 106 positions itself parallel with the wind vector, which in turn positions the offset, the negative wind screen 107 to the left of the incoming wind (or right according to the rotation of the wind turbine), which blocks that part of the wind and diverts it to the side of the structure, eliminating its negative detraction of the oncoming wind vector.

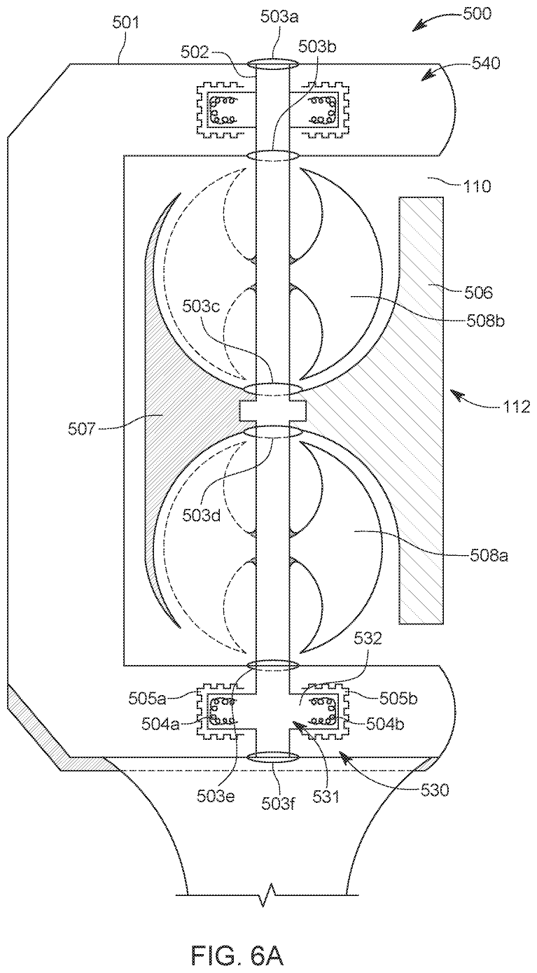

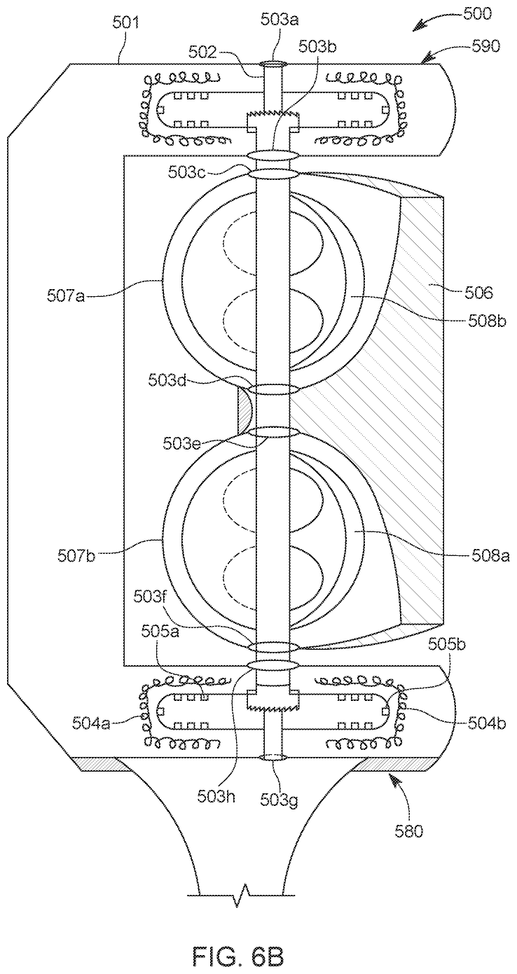

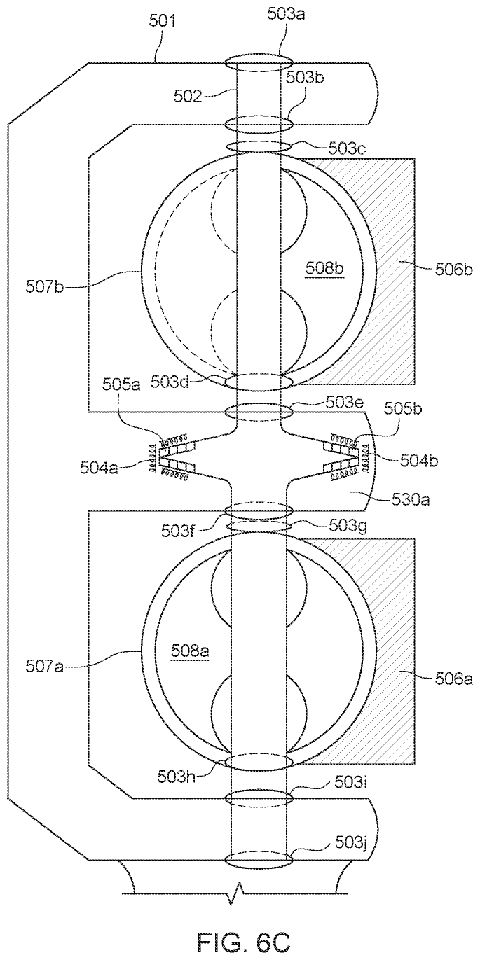

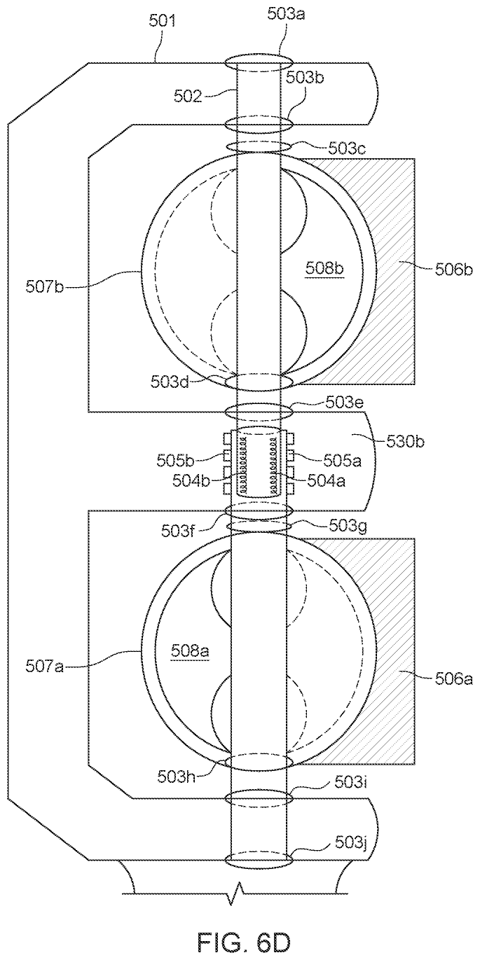

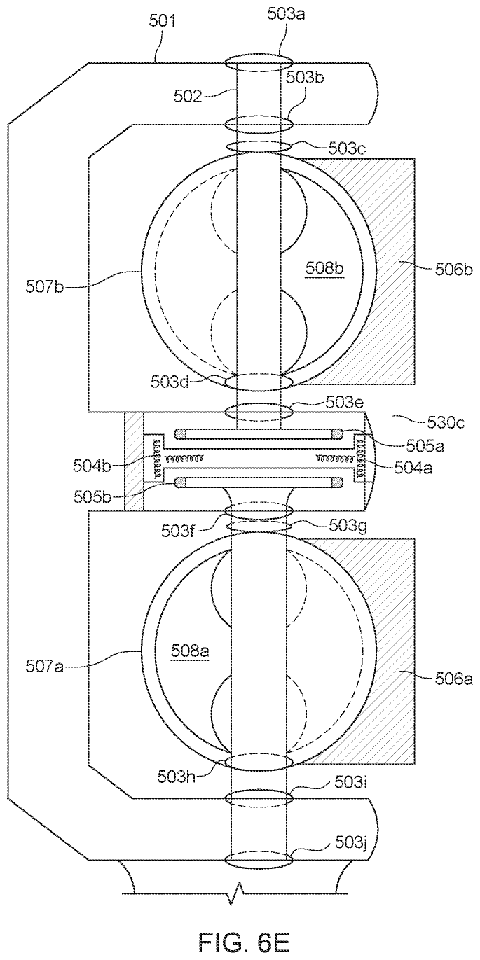

In the examples described above, the wind turbine 100 includes a single set of blades 108 coupled to the shaft 102. In some embodiments, a wind turbine system 500 and/or a wind turbine system 550 can include a wind turbine, which includes multiple sets of blades coupled to a shaft 502, for example, in a stacked arrangement having blades 508a and blades 508b, as illustrated in FIG. 6A-6E. In these examples, the wind direction device 112 can include a wind vane 503 and a negative wind screen 507 that covers both the blades 508a and blades 508b. The wind turbine system 500 and/or the wind turbine system 550 can include one or more generators as described above. For example, as illustrated in FIG. 6B, the wind turbine system 550 can include a generator 580 in the lower arm of the frame 501 and a generator 590 in the upper arm of the frame 501. In another example, as illustrated in FIG. 6A, the wind turbine system 550 can include a generator 530 in the lower arm of the frame 501 and a generator 540 in the upper arm of the frame 501. In this example or any example above, the position of the coils and magnets can be swapped. For example, the magnets can be placed in the rotor, and the coils can be placed in the chamber, and vice versa.

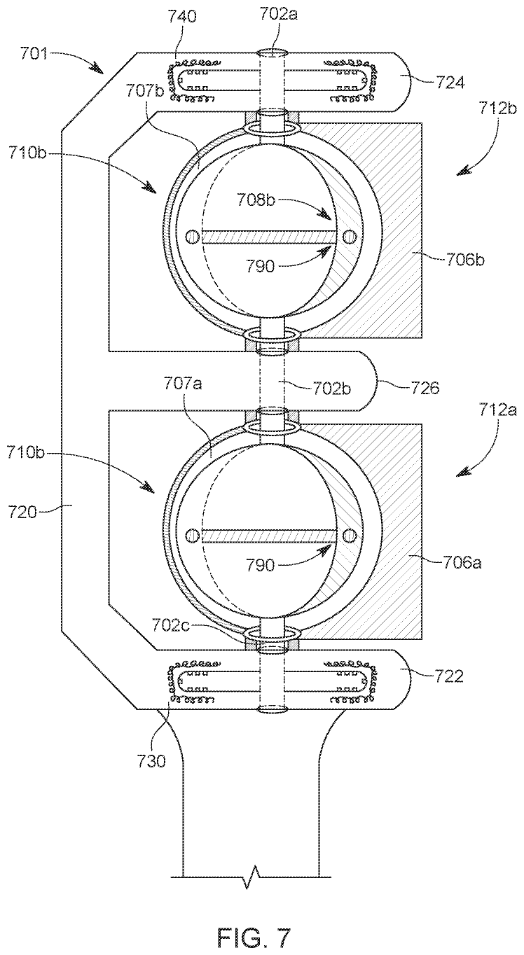

FIG. 7 illustrate examples of a wind turbine system 700, according to aspects of the present disclosure. While FIG. 7 illustrate examples of components of the wind turbine system 700, additional components can be added and existing components can be removed and/or modified.

As illustrated in FIG. 7, which is a cross-sectional view, the wind turbine system 700 includes a frame 701 that supports two wind turbines, a wind turbine 710a and a wind turbine 710b. In some embodiments, as illustrated, the frame 701 can be “E” shaped having a vertical bar 720, a lower arm 722, a middle arm 726, and an upper arm 724. The wind turbine 710a includes a number of blades 708a coupled to a shaft 702. The wind turbine 710b includes a number of blades 708b coupled to multiple independent shafts 702. For example, a shaft 702a extends from the top of the blades 708b into the upper arm 724; a shaft 702b extend through the middle arm 726 from the bottom of the blades 708b to the blades 708a, and vertically from the lower arm 722 to the bottom of the blades 708a, thereby rotatably coupling the wind turbine 710a and wind turbine 710b to the frame 701. The blades 708a and 708b operate to interact with the wind to convert a force of the wind into a torque on the shaft 702. The torque causes the shaft 702 to rotate. As described above, the blades 708a and 708b can be drag-type devices. In some embodiments, the shaft 702b can also be separated into two shafts extending from the middle arm 726.

As discussed herein, the shaft 702 is coupled to one or more generators that operate to convert the mechanical energy of the rotating shaft into electrical energy. The shaft 702 extends into the lower arm 722 and the upper arm 724, and through the middle arm 726. The lower arm 722, middle arm 726, and the upper arm 724 can include bearings, e.g., bearing 703a, 703b, 703c, 703d, 703e, and 703f, that allow the shafts 702a, 702b, and 702c to rotate.

In embodiments, the blades 708a and 708b can include a circular support bar 790 that encircles the wind turbine and passes through the midpoints of the blades 708a and 708b. The circular support bar can be constructed of rigid or semi-rigid material to provide structural support to the blades 708a and 708b. In some embodiments, any of the blades described herein can include a circular support bar.

In one example, as illustrated in FIG. 7, the wind turbine system 700 can include a generator 730 positioned within the lower arm 722 and a generator 740 positioned in the upper arm 724. As described above in detail, the generator 730 and/or generator 740 can include a chamber that houses a rotor. The rotor is coupled to the shaft 702. The chamber is configured to allow the rotor to spin as the shaft 702 spins. The rotor 732 includes magnets or coils positioned around the disk of the rotor and coils or magnets positioned around the chamber. As the rotor spins within the chamber, an electrical current is generated in the coils. A transmission line and/or lines can be coupled to the coils to transmit the generated electrical energy. In other examples, a generator can be positioned in the middle arm 726.

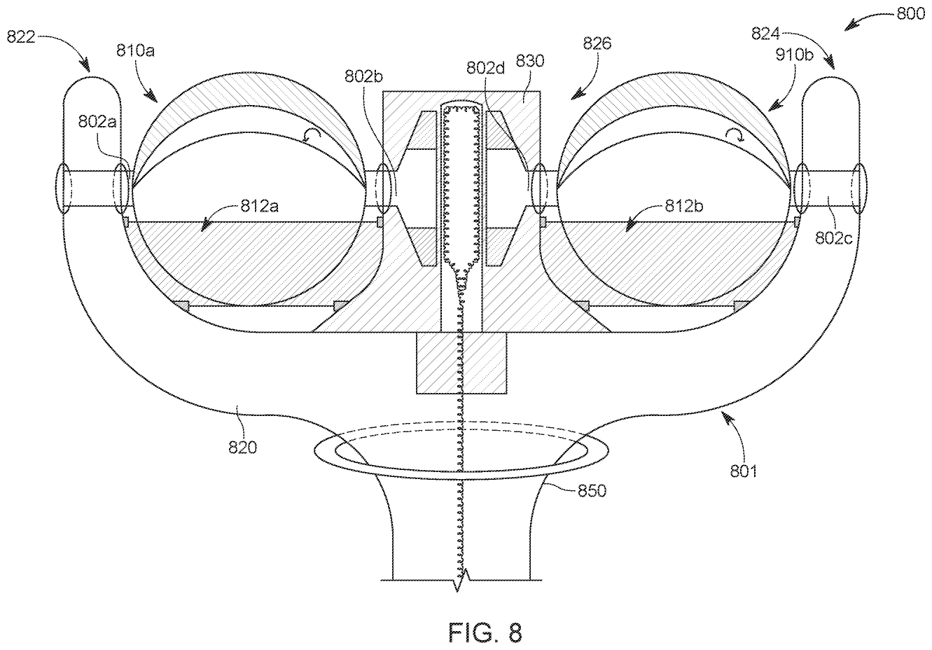

FIG. 8 illustrate an examples of a wind turbine system 800, according to aspects of the present disclosure. While FIG. 8 illustrates examples of components of the wind turbine system 800, additional components can be added and existing components can be removed and/or modified.

As illustrated in FIG. 8, which is a cross-sectional view, the wind turbine system 800 includes a frame 801 that supports two wind turbines, a wind turbine 810a and a wind turbine 810b. In some embodiments, as illustrated, the frame 801 can be configured to support the wind turbine 810a and wind turbine 810b in a horizontal configuration, e.g., the wind turbine 810a and wind turbine 810b horizontally spaced apart. The frame 801 can be horizontal “E” shaped having a horizontal bar 820, a vertical side arms 822 and 824, and a middle arm 826. The wind turbine 810a includes a number of blades 808a coupled to a shaft 802a at one side of the blades 808a and coupled to a shaft 802b at an opposing side of the blades 808a. The wind turbine 810b includes a number of blades 808b coupled to a shaft 802c at one side of the blades 808b and coupled to a shaft 802d at an opposing side of the blades 808b. The shaft 802a extends horizontally from the vertical arm 822, and the shaft 802b extends horizontally from the middle arm 826, thereby rotatably coupling the wind turbine 810a to the frame 801. The shaft 802c extends horizontally from the vertical arm 824 and the shaft 802d extends horizontally from the middle arm 826, thereby rotatably coupling the wind turbine 810b to frame 801. The blades 808a and 808b operate to interact with the wind to convert a force of the wind into a torque on the shaft 802a and shaft 802b, respectively. The torque causes the shaft 802a and shaft 802b to rotate. As described above, the blades 808a and 808b can be drag-type devices.

As discussed herein, the shaft 902a and shaft 902b are coupled to one or more generators, e.g., generator 830, that operate to convert the mechanical energy of the rotating shaft into electrical energy. The vertical arm 822, middle arm 826, and the vertical arm 824 can include bearings that allow the shaft 802 to rotate. In some embodiments, the turbine rotate in the same direction, and the force generated can be additive. The wind turbine system 800 can also include fixed negative wind screens 812a and 812b to block oncoming wind so as to block its effect on the back of the returning blades, i.e., shunting the now negative wind to the side.

The frame 801 can be coupled to a pole or column 850 that holds the frame 801. In some embodiment, the column 850 can include a bearing or a motor that allows frame 801 to rotate to face in a direction of the wind.

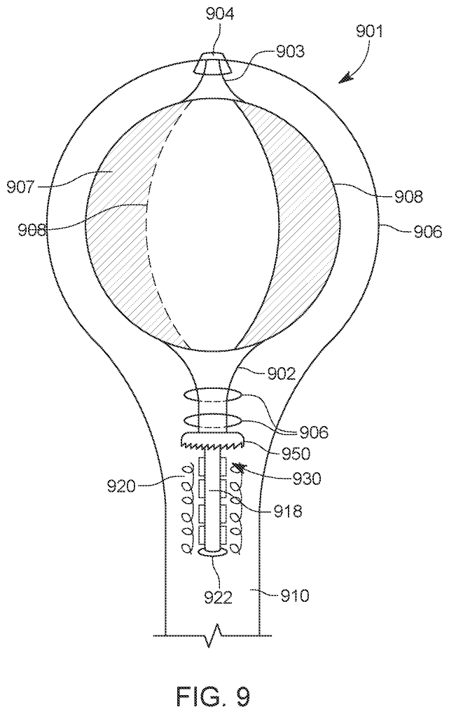

FIG. 9

As illustrated, the costal wind turbine system can include a frame 901 blades 908. The blades can The wind turbine system can also include one or more fixed negative wind screen 907 block oncoming wind so as to block its effect on the back of the returning blades, i.e., shunting the now negative wind to the side. The system can include a cowling 906 for catchment side to enhance East, or West (AM/PM) wind. An additional cowling would be on the inner side of the catchment blade after construction of the negative screen on the upwind side. The system can include a top axle 903 and a bottom axle 902 coupled to the top and bottom of the blades 908, respectively. The system can include can include bearings 904, 906, and 922 that allow the axles 902 and 903 to rotate.

In embodiments, the system can include a planetary gear (epicyclic gear) 950 to increase axle 902 and 903 angular velocity. The planetary gear 950 is a gear system consisting of one or more outer, or planet, gears or pinions, revolving about a central sun gear or sun wheel. The planet gears are mounted on a movable arm or carrier, which itself may rotate relative to the sun gear. Planetary gear 950 can incorporate the use of an outer ring gear or annulus, which meshes with the planet gears. While not shown, any of the wind turbine systems described above can include a planetary gear.

The system also includes a generator 830 including stator coil arrays 930 and spinning magnets 918 coupled to the axle 902. The wind turbine can be installed on a tower 910. The tower 910 can include a prow on the E and W ends and a circular on the N/S sides. In some embodiments, the tower 910 can be a minimum of 25 feet in length from the ground to the bottom edge of the electronics to remain above flood surges.

In some embodiment, the blades 908 can be constructed as described above. In some embodiments, a 5-bladed “sphere” where each blade is a mirror image of its back side (imagine the chess pawn split down the middle). This design can duplicate the effect of east wind in the opposite direction when it is from the west as morning and evening land/ocean mass temperatures change during each 24-hour period to create short-term but strong prevailing winds. Many countries have shorelines for this, although the orientation may differ from E/W such as on the East Coast of America. The foregoing depiction is on the right, but the left would be fine because, in either case, the spin of the “sphere” can be clockwise and then counter clockwise, or vice-versa as the wind vector varies, so the position of the blocking screen would never vary depending which alternative is used.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A wind turbine system, comprising:
a frame comprising a first arm and a second arm;
a wind turbine coupled between the first arm and the second arm, the wind turbine comprising:
at least one shaft,
a plurality of blades coupled to the shaft, wherein the plurality of blades interact with a wind to rotate the shaft, and
a wind direction device, wherein the wind direction device is configured to block the wind from interacting with one or more of the plurality of blades moving in a movement direction counter to a wind direction of the wind; and
at least one generator coupled to the wind turbine, wherein the generator is configured to convert mechanical energy of the wind turbine to electrical energy.

2. The wind turbine system of claim 1, wherein the at least one generator comprises:
a rotor coupled to at least one shaft;
a plurality of magnets positioned on the rotor; and
a plurality of coils surrounding the rotor.

3. The wind turbine system of claim 2, wherein rotor is a circular disk.

4. The wind turbine system of claim 1, further comprising:
an additional wind turbine coupled between the first arm and the second arm, the wind turbine.

5. The wind turbine system of claim 4, wherein the wind direction device is configured to block the wind from interacting with one or more of a plurality of additional blades of the additional wind turbine from moving in the movement direction counter to the wind direction of the wind.

6. The wind turbine system of claim 4, further comprising:
at least one additional generator coupled to the additional wind turbine.

7. The wind turbine system of claim 1, further comprising:
a third arm coupled to the frame
an additional wind turbine coupled between the third arm and the second arm, the wind turbine comprising:
at least one additional shaft,
a plurality of additional blades coupled to the at least one additional shaft, wherein the plurality of additional blades interact with the wind to rotate the shaft, and
an additional wind direction device, wherein the additional wind direction device is configured to block the wind from interacting with one or more of the plurality of additional blades moving in the movement direction counter to the wind direction of the wind.

8. The wind turbine system of claim 7, further comprising:
at least one additional generator coupled to the additional wind turbine.

9. The wind turbine system of claim 7, wherein the additional wind turbine is positioned horizontally relative to the wind turbine.

10. The wind turbine system of claim 1, wherein plurality of blades are scoop shaped.
